(19) United States
(12) Patent Application Publication
(10) Pub. No.: US 2008/0251583 A1
(43) Pub. Date: Oct. 16, 2008

(54) Card reader for automated teller machine

(75) Inventor: Myung Hwan Ko, Gyeonggi-do (KR)

Correspondence Address: BACON & THOMAS, PLLC, 625 SLATERS LANE, FOURTH FLOOR, ALEXANDRIA, VA, 22314-1176, US

(73) Assignee: Nautilus Hyosung Inc., Seoul (KR)

(21) Appl. No.: 12/003,538

(22) Filed: Dec. 28, 2007

(30) Foreign Application Priority Data
Apr. 10, 2007 (KR) 10-2007-0035120

(51) Int. Cl. G06K 7/08

(52) U.S. Cl. 235/449

(57) ABSTRACT

A card reader for an ATM includes a card insertion part, a header disposed on one side of the card insertion part to read out the information stored in the card, and a protrusion formed on a front surface of the card insertion part to be horizontally aligned with the header along a card insertion direction, thereby prohibiting an illegal device from being attached to the card reader.

### FIELD OF THE INVENTION

The present invention relates to a card reader for an automated teller machine that can prohibit an illegal device such as an illegal card reader from being attached to the card reader, thereby preventing card information from leaking.

### BACKGROUND OF THE INVENTION

FIG. 1 is an exterior perspective view showing the external appearance of an automated teller machine.

As shown in FIG. 1, an automated teller machine 10 (hereinafter, referred to as “ATM) includes a key input unit 11 that converts information input by a user into an electrical signal, a print unit 12 that prints transaction details on a bankbook, and prints a transaction slip, a cash depositing/drawing part 13 in which cashes or checks to be dispensed are stacked during the transaction, a display unit 14 that displays the transaction details on a display screen, and a bankbook/card reader 15 that recognizes a bankbook or a card to be inserted.

As shown in FIG. 2, the bankbook or the card is provided with a magnetic stripe ‘M’ thereon which has information to be read by the bankbook/card reader 15. The bankbook/card reader 15 generally includes a bankbook/card insertion part 15a, and a header 15b that is disposed to face the magnetic stripe M on the bankbook or the card C inserted into the bankbook/card insertion part 15a to read the information stored in the magnetic stripe M.

Recently, some people with bad intentions read card information from people who use the ATM, copy the information to another cards, and use the forged cards. For this reason, people who use the ATM often suffer from financial loss. That is, as shown in FIG. 3, an illegal card reader 20 as an illegal device is attached to a front surface of the bankbook/card reader 15, and when the card C passes through the illegal card reader 20, reads the card information through a second header 21 mounted on the illegal card reader 20. Then, the card information is copied to another card to forge the card.

### SUMMARY OF THE INVENTION

Therefore, it is an object of the present invention to provide a card reader for an automated teller machine (ATM) that, when an illegal device is attached to a front surface of the card reader for an ATM, enables a user to recognize the fact that the illegal device is attached.

It is another object of the present invention to provide a card reader for an ATM that can prohibit an illegal device from being attached to a front surface of the card reader for an ATM.

According to a first aspect of the present invention, there is provided a card reader for an ATM that supports various financial transactions on the basis of information stored in a magnetic stripe of a card. The card reader includes a card insertion part where the card is inserted into or ejected from, a header that is disposed on one side of the card insertion part to read out the information stored in the magnetic stripe of the card, and a protrusion formed on a front surface of the card insertion part to be horizontally aligned with the header along a card insertion direction.

The protrusion may be formed to be inclined at a predetermined angle with respect to a horizontal surface of the card insertion part.

A sensor that detects an illegal device may be coupled to the protrusion.

According to a second aspect of the present invention, there is provided a card reader for an ATM that supports various financial transactions on the basis of information stored in a magnetic stripe of a card. The card reader includes a card insertion part where the card is inserted into or ejected from, and a header that is disposed on one side of the card insertion part to read out the information stored in the magnetic stripe of the card, wherein a front end of the card insertion part that is horizontally aligned with the header is formed to be inclined at a predetermined angle along a card insertion direction.

According to the aspects of the present invention, since one side of a front surface of the card reader for an ATM is formed to protrude forward, a user can easily recognize the illegal device that is to be attached to the front surface of the card reader, thereby prohibiting the illegal device from being attached. Therefore, the card information can be prevented from leaking by the illegal device attached to the front surface of the card reader, and as a result, the financial loss of the user can be prevented.

### BRIEF DESCRIPTION OF THE DRAWINGS

FIG. 1 is a diagram showing the external appearance of a related art ATM;

FIG. 2 is a cross-sectional view illustrating the essential parts of a bankbook/card reader shown in FIG. 1;

FIG. 3 is a cross-sectional view showing an example where an illegal card reader is attached to the bankbook/card reader shown in FIG. 2;

FIG. 4 is a cross-sectional view showing the essential parts of a card reader for an ATM, e.g., as shown in FIG. 1, according to a first embodiment of the present invention;

FIG. 5 is a diagram illustrating another example of the card reader shown in FIG. 4;

FIGS. 6A and 6B are diagrams illustrating problems when an illegal card reader is attached to the card reader shown in FIG. 5; and

FIG. 7 is a cross-sectional view showing the essential parts of a card reader for an ATM, e.g., as shown in FIG. 1, according to a second embodiment of the present invention.

### DETAILED DESCRIPTION OF THE EMBODIMENTS

Hereinafter, embodiments of the present invention will be described.

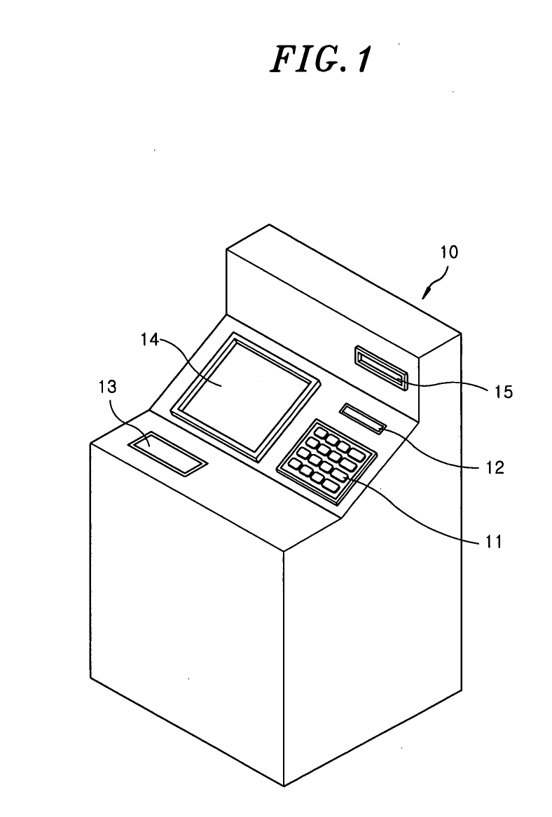

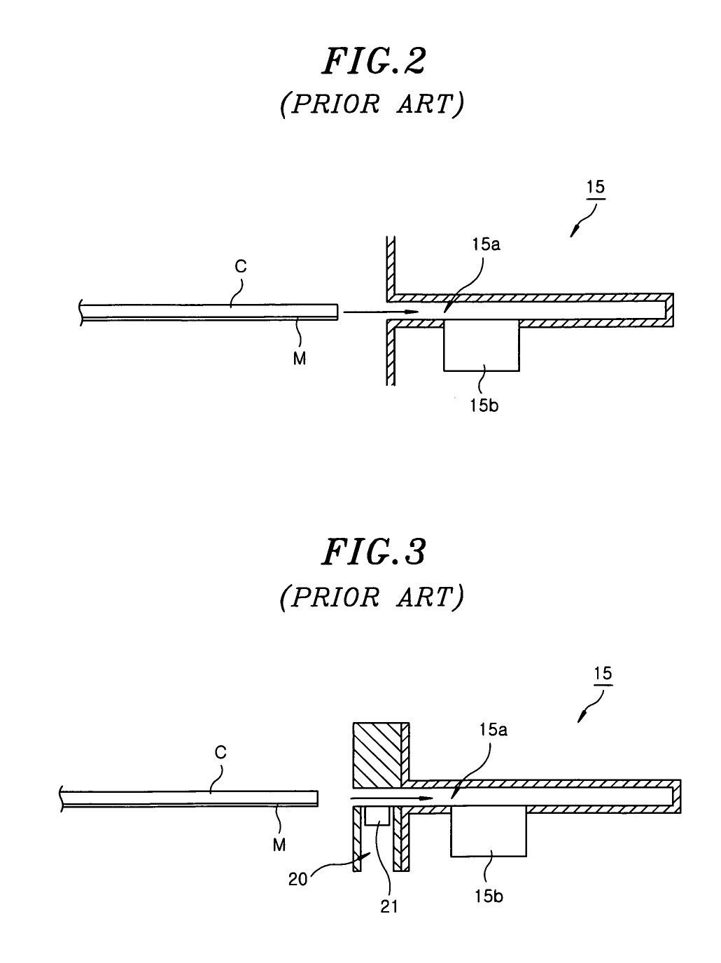

FIG. 4 is a cross-sectional view showing the essential parts of a card reader 100 for an ATM, e.g., as shown in FIG. 1, according to a first embodiment of the present invention.

As shown in FIG. 4, the card reader 100 for an ATM includes a card insertion part 110 through which a card C is inserted, and a header 120 that is disposed on one side of a card insertion slot 110a of a card insertion part 110 to readout card information stored in a magnetic stripe ‘M’ of a card ‘C’, which is to be inserted into the card insertion slot 110a, in a contact manner. A protrusion 111 is formed to protrude forward on one side of a front surface of the card insertion part 110.

The protrusion 111 protrudes to be horizontally aligned with the header 120 on the front surface of the card insertion part 110. The protrusion 111 may be formed integrally with the card insertion part 110 or may be formed separately from the card insertion part 110 and attached to the card insertion part 110. Such a protrusion 111 serves to prevent an illegal device from being attached to the card reader 110 as will be described hereinafter.

The length of the protrusion 111 is preferably set such that the card C can be easily inserted into and ejected from the card insertion part 110.

If a separate illegal device, that is, an illegal card reader 20, is illegally attached to a front surface of the card reader 100, a second header 21 for reading out the information stored in the magnetic stripe M of the card C should be disposed to be horizontally aligned with the header 120 along a card insertion direction of the card insertion part 110. Accordingly, when the illegal card reader is attached, since it is attached to protrude by a predetermined length or more, a user can easily recognize visually the attachment of the illegal card reader 20. In addition, since the user can easily recognize the attachment of the illegal card reader 20, it is possible to prohibit a person with bad intention from attaching the illegal card reader.

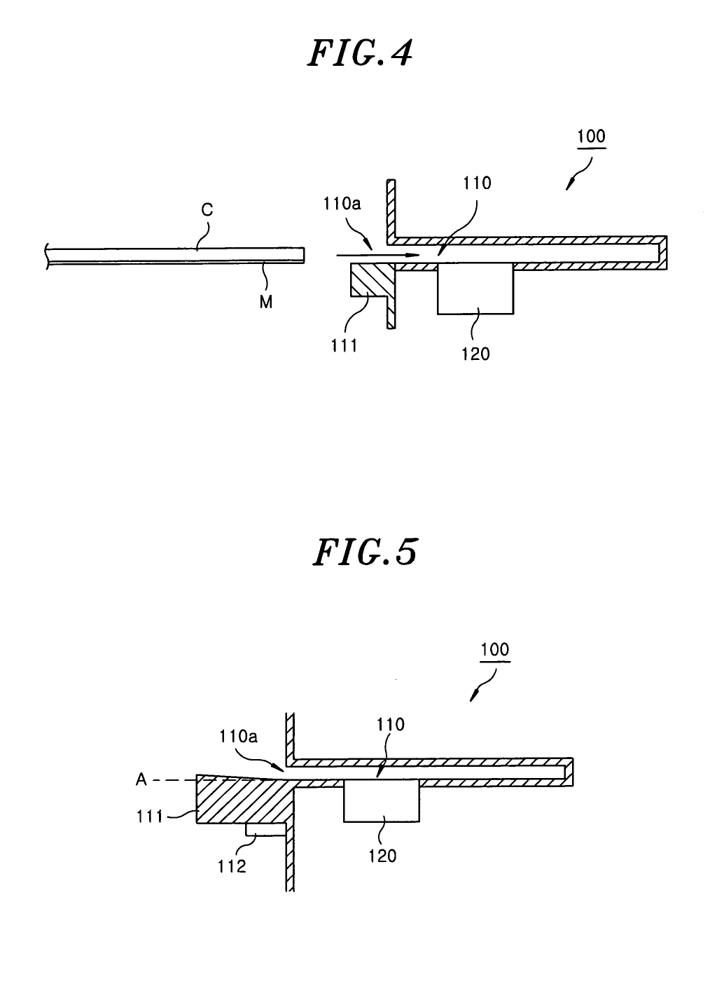

Alternatively, as shown in FIG. 5, the protrusion 111 may be formed to be inclined toward card insertion part 110 at a predetermined angle along the card insertion direction with respect to a horizontal (or a base) surface ‘A’ of the card insertion part 110. For example, the protrusion 111 may be provided on an upper side or a lower side of the front surface of the card insertion part 110 according to the position of the header 120. Accordingly, when the protrusion 111 is formed on the upper side of the card insertion part 110, it may be inclined downward. In addition, when the protrusion 111 is formed on the lower side of the card insertion part 110, it may be inclined upward. In this regard, the inclination angle of the protrusion 111 is preferably set such that the card can be easily inserted into and ejected from the card insertion part 110 without being obstructed by the protrusion 111.

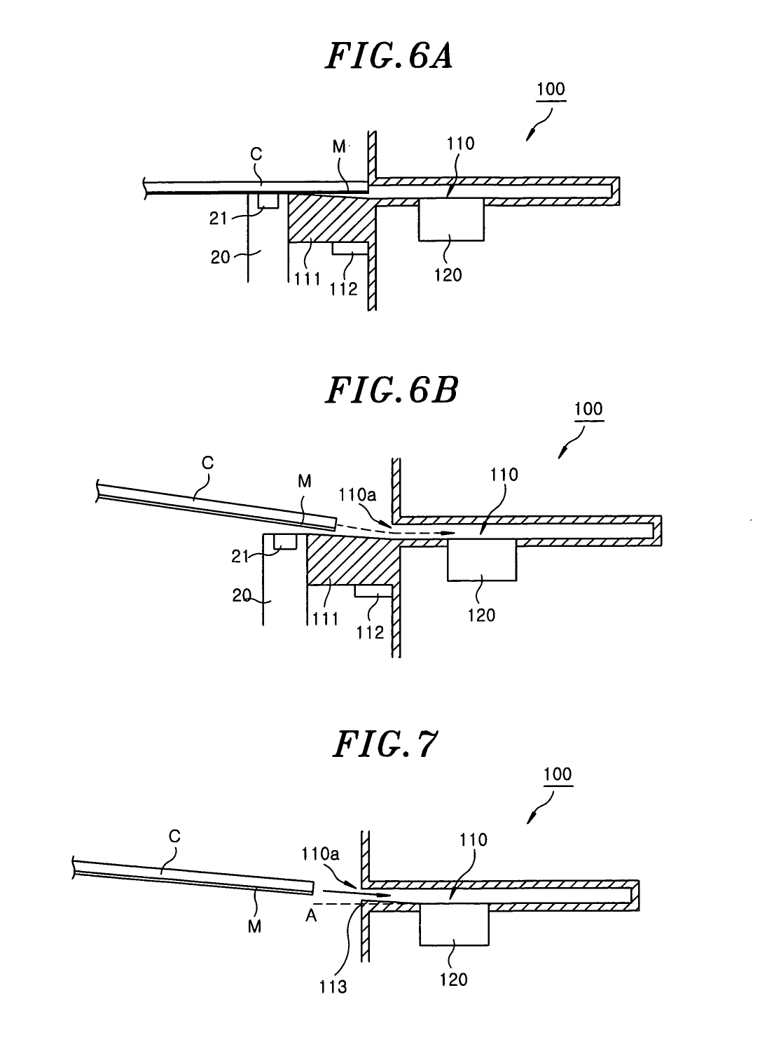

FIGS. 6A and 6B are exemplary diagrams illustrating problems occurring when the illegal card reader 20 as an illegal device is attached in a case where the protrusion 111 is formed to be inclined.

As shown in FIG. 6A, when the illegal card reader 20 is attached in parallel with a horizontal direction of the protrusion 111, considering that the user generally pushes in the card C in parallel with a card insertion surface, the card C is not easily inserted into the card insertion part 110.

In this case, as shown in FIG. 6B, the illegal card reader 20 may be attached to correspond to an inclined surface of the protrusion 111. However, since the card C is bent when being inserted into the card insertion part 110, the card Cis not easily inserted into the card insertion part 110.

A sensor 112 is installed on one side of the protrusion 111 to detect the attachment of the illegal card reader 20 as an illegal device. Such a sensor 112 may preferably be an optical sensor. More specifically, the optical sensor 112 is configured to detect whether or not the illegal card reader 20 is attached by receiving an optical signal reflected from the illegal card reader 20.

FIG. 7 is a cross-sectional view showing the essential parts of a card reader 100 for an ATM, e.g., as shown in FIG. 1, according to a second embodiment of the present invention. As shown in FIG. 7, one front end of a card insertion slot 110a of a card insertion part 110 in a card reader 100 is formed to have an inclined surface 113 at a predetermined angle or an elevated surface with respect to a horizontal (or a base) surface ‘A’ of the card insertion part 110. At this time, the inclined surface 113 of the card insertion slot 110a is preferably set to be aligned with the header 120 along the card insertion direction. Furthermore, the inclination angle of the inclined surface 113 is set such that the card C can be easily inserted into and ejected from the card insertion part 110.

According to the embodiments as set forth above, one side of the front surface of the card reader 100 for the ATM is formed to protrude forward or to be inclined. Therefore, the user can easily recognize the illegal device that is to be attached to the front surface of the card reader, thereby prohibiting the illegal device from being attached.

As a result, the card information can be prevented from leaking by the illegal device, which is attached to the front surface of the card reader, thereby preventing the financial loss of the user.

While the invention has been shown and described with respect to the preferred embodiments, it will be understood by those skilled in the art that various changes and modification may be made without departing from the scope of the invention as defined in the following claims.

What is claimed is:

1. A card reader for an automated teller machine that supports various financial transactions on the basis of information stored in a magnetic stripe of a card, the card reader comprising:
a card insertion part where the card is inserted into or ejected from;
a header that is disposed on one side of the card insertion part to read out the information stored in the magnetic stripe of the card; and
a protrusion formed on a front surface of the card insertion part to be horizontally aligned with the header along a card insertion direction.

2. The card reader of claim 1, wherein the protrusion is formed to be inclined at a predetermined angle with respect to a horizontal surface of the card insertion part.

3. The card reader of claim 1, further comprising a sensor that detects an illegal device and is coupled to the protrusion.

4. The card reader of claim 2, further comprising a sensor that detects an illegal device and is coupled to the protrusion.

5. A card reader for an automated teller machine that supports various financial transactions on the basis of information stored in a magnetic stripe of a card, the card reader comprising:
a card insertion part where the card is inserted into or ejected from, wherein a front end of the card insertion part is formed to have an elevated surface with respect to a base surface of the card insertion part; and
a header that is disposed on one side of the card insertion part to read out information stored in the magnetic stripe of the card.
